(19) United States
(12) Patent Application Publication
(10) Pub. No.: US 2025/0069138 A1
(43) Pub. Date: Feb. 27, 2025

(54) Method for Constructing Investment Portfolios

(71) Applicants: Yi-Min Lan, Pingtung (TW); Hung-Wen Cheng, Taipei City (TW)

(72) Inventors: Yi-Min Lan, Pingtung (TW); Hung-Wen Cheng, Taipei City (TW)

(21) Appl. No.: 18/472,798

(22) Filed: Sep. 22, 2023

(30) Foreign Application Priority Data
Aug. 21, 2023 (TW) 112131332

(51) Int. Cl. G06Q 40/04; G06Q 40/06

(52) U.S. Cl. CPC G06Q 40/04; G06Q 40/06

(57) ABSTRACT

The present invention proposes a method for constructing investment portfolios, which includes calculating the logarithmic return and the momentum factor through a processor based on historical stock prices, storing the logarithmic return and the momentum factor, the processor calculates the information coefficient (IC) values based on the logarithmic return and momentum factor, and stores the IC values as an investment target screening indicators, utilizes the processor to exanimate the momentum IC value in the time interval, deletes the stocks whose stock price is too small, ranks and stores the stocks according to the strength of the momentum, and utilizes the processor to determine the stock list in the portfolio based on the ranking by the equal weighting method, and then stores the portfolio.

### TECHNICAL FIELD

The present invention relates to technical field of investment strategy construction, and more particularly a method for construction an investment portfolio through a computer executable program.

### BACKGROUND

Financial investment is a common financial management method for people. With the post-2020 COVID-19 pandemic era, operating costs and social turmoil and other factors, the inflation rate has risen rapidly, and commodity prices have repeatedly hit new highs. People's purchasing power will continue to decline over time, if they keep their money in the bank. During era of high inflation, high commodity prices, and low wages, the importance of investment and financial management is even more prominent.

With the rapid development of artificial intelligence (AI), together with the booming stock market, there exists demanding to construct models and make investments and profits according to specific trading strategies through increasing program trading. Specifically, how to find patterns and make inductions from the huge historical data, so as to further construct investment portfolios with different meanings for performance comparison and to optimize the allocation proportion of assets so that investment positions have excess returns and smaller risks.

In order to focus on further investment strategies, add some data conditions and parameter conditions, such as the length of the momentum formation period and the holding period, the equal fraction of the stock group, etc., so as to observe the performance of the investment portfolio. In addition, constructing a trading strategy mainly focuses on its returns, so it is necessary to use indicators that can evaluate investment performance of the constructed investment portfolio. The present invention selects the information coefficient (IC) as the measurement for constructing an investment portfolio. The information coefficient can demonstrate how well financial forecasts match actual financial results. This allows people to construct an investment portfolio that outperforms market returns and earn stable returns.

This invention will explore whether the momentum factor can be used to construct an investment portfolio, what interval length of the momentum factor is better, whether the IC value can be used as an indicator for constructing an investment portfolio, what kind of machine learning effect is better, and whether it has financial phenomenon (short-term momentum reversal, long-term momentum and stock returns are positively correlated) and compare nine investment portfolios constructed using momentum strategies and reverse momentum strategies to determine which portfolio performs better.

### SUMMARY OF THE INVENTION

The purpose of the present invention is to propose a method for constructing investment portfolios, according to one aspect of the present invention, the method includes performing the following steps through a computer executable program by a processor: calculating logarithmic return and the momentum factor through the processor based on historical stock prices, and storing the logarithmic return and the momentum factor; calculating information coefficient (IC) values by the processor based on the logarithmic return and the momentum factor, and storing the IC values as screening indicators for investment; utilizing the processor to exanimate the IC values in a time interval, deleting stocks whose stock price is too small, ranking and storing the stocks according to strength of the momentum factor to make ranking order; and determining a stock list in a investment portfolio by the processor based on dividing the stocks into groups according to the ranking order, and then stores the portfolio.

In some embodiments, a method for constructing investment portfolios further comprising a machine learning model to predict IC values for next time period after performing steps of calculating the IC values.

In some embodiments, the momentum factor includes at least one of the following: return momentum, simple momentum factor, relative strength index (RSI), moving average, MACD, profit momentum factor, capital investment momentum factor, fundamental factor, economic indicator and index momentum factor. If the IC values are positive, a momentum strategy is carried out; if the IC values are negative, a reverse momentum strategy is carried out.

In some embodiments, two different observation methods are utilized to construct investment portfolio. The first method is containing the following approaches: (1) TB/BT: Buy Top and Sell Bottom when the IC value is positive; Buy Bottom and Sell Top when the IC value is negative; (2) buyT/buyB: Buy Top when the IC value is positive; Buy Bottom when the IC value is negative; (3) buyT/sellB: Buy Top when the IC value is positive; Sell Bottom when the IC value is negative; (4) sellB/sellT: Sell Bottom when the IC value is positive; Sell Top when the IC value is negative; and wherein the stocks are divided into groups that group with the strongest momentum is labeled as “Top”, while the group with the weakest momentum is labeled as “Bottom”. The second method disregarding whether the predicted IC value is positive or negative and applying the same operation in all cases. This second method is containing the following approaches: (1) buyT: Buy Top; (2) buyB: Buy Bottom; (3) sellT: Sell Top; (4) sellB: Sell Bottom; (5) buyTsellB: Buy Top and Sell Bottom simultaneously; and wherein the stocks are divided into groups that group with the strongest momentum is labeled as “Top”, while the group with the weakest momentum is labeled as “Bottom”.

In some embodiments, the momentum factor is calculated by taking m months as the formation period, divides current closing price of a stock in current period by the closing price of the stock in previous m months, and takes logarithm. Each of the IC values is calculated as covariance of two variables divided by product of their respective standard deviations. The IC values are Rank IC values, each Rank IC value is defined as correlation coefficient in the cross section between a ranking of a target factor and a ranking of return of holding for h months at time t.

According to another aspect of the present invention, the method includes performing the following steps through a computer executable program by a processor: calculating logarithmic return and the momentum factor through the processor based on historical stock prices, and storing the logarithmic return and the momentum factor; calculating information coefficient (IC) values by the processor based on the logarithmic return and the momentum factor, and storing the IC values as screening indicators for investment; predicting IC values for next time period by the processor through a machine learning model; utilizing the processor to exanimate the IC values in a time interval, deleting stocks whose stock price is too small, ranking and storing the stocks according to strength of the momentum factor to make ranking order; and determining a stock list in a investment portfolio by the processor based on dividing the stocks into groups according to the ranking order, and then stores the portfolio.

### BRIEF DESCRIPTION OF THE DRAWINGS

FIG. 1 shows a flow chart of the research steps of the actual Information Coefficient (IC) proposed by the present invention.

FIG. 2 shows a flow chart of research steps for predicting IC values using machine learning according to the present invention.

FIG. 3 shows a schematic diagram showing the calculation of return momentum and return according to an embodiment of the present invention.

FIG. 4 illustrates examples of a regression tree showing the random forest method.

FIG. 5 illustrates schematic neural network.

FIG. 6 illustrates histogram of winning percentage of investment portfolio that calculates 1% of the stocks in 9 investment portfolios, where both top group (Top) and the bottom group (Bottom) containing 50 stocks, by equal weighting method to do long or short for strong stocks or weak stocks.

FIG. 7 illustrates histogram of average excess returns of investment portfolio that calculates 1% of the stocks in 9 investment portfolios, where both top group (Top) and the bottom group (Bottom) containing 50 stocks, by equal weighting method to do long or short for strong stocks or weak stocks.

FIG. 8 illustrates 100-month cumulative return trend chart of investment portfolio that calculates 1% of the stocks through buyT/sellB depended on the IC values (positive or negative), where both top group (Top) and the bottom group (Bottom) containing 50 stocks, by equal weighting method to do long or short for strong stocks or weak stocks.

FIG. 9 illustrates 100-month cumulative return trend chart of investment portfolio that calculates 1% of the stocks through buyT, where top group (Top containing 50 stocks), by equal weighting method to do long for strong stocks.

FIG. 10 illustrates 100-month cumulative return trend chart of investment portfolio that calculates 1% of the stocks through sellB, where the bottom group (Bottom) containing 50 stocks, by equal weighting method to do short for weak stocks.

FIG. 11 illustrates 100-month cumulative return trend chart of investment portfolio that calculates 1% of the stocks through buyTsellB simultaneously, where both top group (Top) and the bottom group (Bottom) containing 50 stocks, by equal weighting method to do long or short for strong stocks or weak stocks.

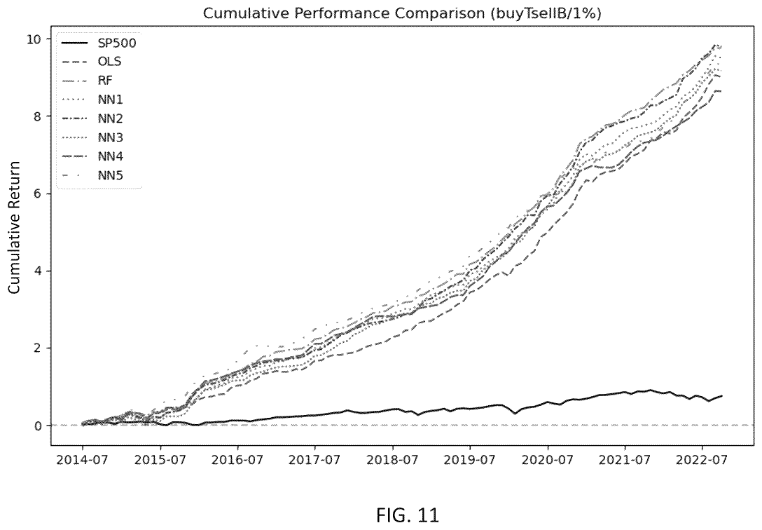

FIG. 12 illustrates the ranking of the importance of various momentum factors for different machine learning models, based on different formation periods.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The Information Coefficient (IC) is a measure used to assess the predictive ability of investment strategies or models. It calculates the correlation between observed data and actual returns, where the data can represent different characteristics or macroeconomic variables. In this invention, the IC values were computed using momentum factors and logarithmic returns as predictive indicators. Pearson Correlation is used as a statistical method to calculate the IC values, which measures the degree of linear correlation between these two sets of data. The IC value is calculated as the covariance of the two variables divided by the product of their respective standard deviations. In this context, X represents the momentum data, and Y represents the returns. It can be expressed as follows:

$$IC = {ρ}_{X , Y} = \frac{Cov ( X , Y )}{{σ}_{X} {σ}_{Y}} = \frac{E [ ( X - {μ}_{X} ) ( Y - {μ}_{Y} ) ]}{{σ}_{X} {σ}_{Y}} \qquad ( 1 )$$

The correlation between the target factor and the return can be determined through the Information Coefficient (IC). The IC value ranges from 1 to −1. When the IC value is greater than 0, it indicates a positive relationship between the current factor and return. Conversely, when the IC value is less than 0, it indicates a negative relationship between the current factor and the return. The larger the absolute value of the IC, the greater the influence of the factor on the return of investment. There are two common types of IC values:

(i) Normal IC: The correlation coefficient in the cross section between the target factor and the return of holding for h months at time t.

$$Normal {IC}_{t} = corr ( {M}_{t , m} , {R}_{t + h} ) \qquad ( 2 )$$

(ii) Rank IC: The correlation coefficient in the cross section between the ranking of the target factor and the ranking of the return of holding for h months at time t.

$$Rank {IC}_{t} = corr ( r ( {M}_{t , m} ) , r ( {R}_{t + h} ) ) . \qquad ( 3 )$$

Where r(M_{t,m}) and r(Rₜ₊ₕ) indicate that the momentum data and logarithmic return have been ranked before calculating the related coefficients. In this invention, we use Rank IC because Normal IC requires data to follow a normal distribution, which is often not the case with financial data.

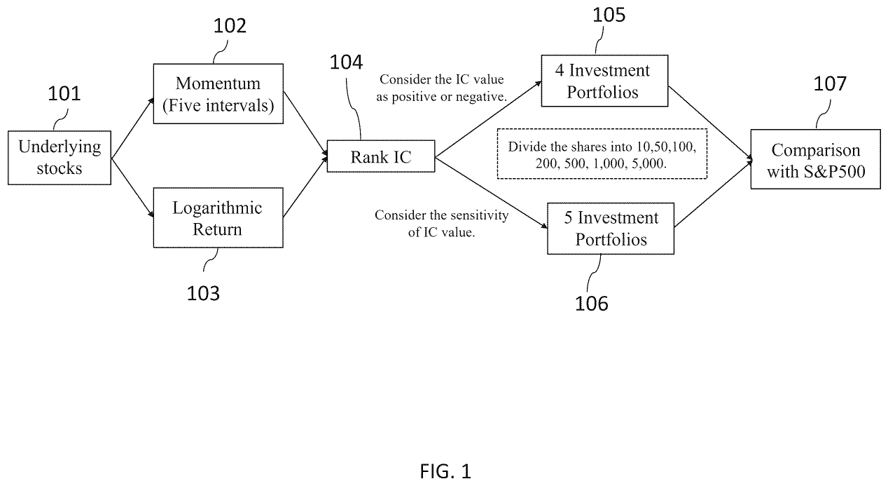

Purpose of this invention is to propose a method for constructing investment portfolios by utilizing linear model and machine learning. This invention can be broadly divided into two main parts. The first part focuses on calculating the actual Information Coefficient (IC) as a screening indicator for investment. Initially, the emphasis is on the real IC values rather than incorporating predictions. Stocks with strong and weak performance of momentum are selected based on the actual IC values, and different investment portfolios are constructed accordingly. The objective is to examine whether these portfolios, utilizing the actual IC values, can generate excess returns. This part aims to evaluate whether the IC values calculated using momentum can truly imply excess returns and serve as indicators for distinguishing between strong and weak momentum of stocks. The research steps for the first part, which focuses on actual IC values, are illustrated in FIG. 1.

FIG. 1 shows a flow chart of the research steps of the actual Information Coefficient (IC) proposed by the present invention.

In one embodiment, the steps of the aforementioned actual Information Coefficient (IC) may include: Step 101, utilizing historical stock prices, for example, from the Center for Research in Security Prices (CRSP) closing price data period from January 1995 to October 2022, a total of 334 months of closing price data; Step 102, calculating the momentum of all stocks in the m-month formation period; Step 103, calculating the logarithmic rate of return for the holding period of h months; then in step 104, calculating the historical momentum IC value: this step is performed by ranking all the momentum factors with a formation period of m months and the logarithmic return with a holding period of h months, and calculating the historical momentum Rank IC, at this time, where the IC value is a vector and the stocks are divided into groups of 10, 20, 50, 100, 200, 500, 1000 and 5000, with each group containing 500, 100, 50, 25, and 1 stock respectively, to construct the investment portfolio according to the momentum from high to low; Step 105, if the predicted IC value is positive, it means that the momentum factor has a positive relationship with the return rate of the next period, and the momentum strategy is carried out; if the predicted IC value is negative, it means that the momentum factor has a negative relationship with the return rate of the next period, and the reverse momentum strategy is carried out; a total of four investment portfolio construction methods: (1) TB/BT: Buy Top and Sell Bottom when the IC value is positive; Buy Bottom and Sell Top when the IC value is negative; the return is calculated as the difference in returns between the two groups of stocks; (2) buyT/buyB: Buy Top when the IC value is positive; Buy Bottom when the IC value is negative; (3) buyT/sellB: Buy Top when the IC value is positive; Sell Bottom when the IC value is negative; (4) sellB/sellT: Sell Bottom when the IC value is positive; Sell Top when the IC value is negative; Step 106, disregarding whether the obtained predicted IC value is positive or negative and applying the same operation in all cases; this results in five construction methods: (1) buyT: Buy Top; (2) buyB: Buy Bottom; (3) sellT: Sell Top; (4) sellB: Sell Bottom; (5) buyTsellB: Buy Top and Sell Bottom simultaneously; Step 107, observing the difference between the portfolio return and the logarithmic return of the market (S&P500).

According to an embodiment of the present invention, the stocks in the dominant group represent the stocks with the highest ranking; the stocks in the disadvantaged group represent the stocks with the lowest ranking.

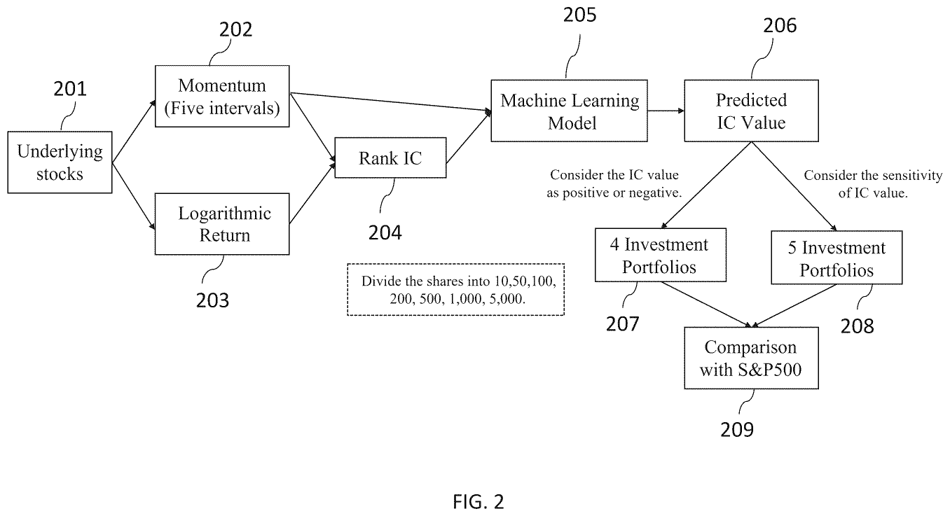

Based on the initial conclusions drawn from the first part, it provides motivation for the second part of the present invention. If the investment portfolios using the actual IC values can effectively deliver robust excess returns, the present invention will employ machine learning models to predict IC values and obtain a list of companies for the portfolios in advance. This approach aims to achieve similar robust excess returns. The method proposed by the present invention containing steps for the second part, involving the application of machine learning, are illustrated in FIG. 2.

In one embodiment, the steps of the aforementioned actual Information Coefficient (IC) involving the application of machine learning may include: Step 201, utilizing historical stock prices, for example, from the Center for Research in Security Prices (CRSP) closing price data period from January 1995 to October 2022, a total of 334 months of closing price data; Step 202, calculating the momentum of all stocks in the m-month formation period; Step 203, calculating the logarithmic rate of return for the holding period of h months; then in Step 204, calculating the historical momentum IC value, at this time, where the IC value is a vector; Step 205, the above historical momentum IC values being put into the machine learning model (seven models); and then in Step 206, the momentum IC values of the next period are predicted, the five values with the largest momentum IC values in the formation period are selected, and the stocks being constructed an investment portfolio by sorting the momentum from high to low and dividing it into groups of 10, 20, 50, 100, 200, 500, 1000 and 5000, with each group containing 500, 100, 50, 25, and 1 stock respectively; Step 207, if the predicted IC value is positive, it means that the momentum factor has a positive relationship with the return rate of the next period, and the momentum strategy is carried out; if the predicted IC value is negative, it means that the momentum factor has a negative relationship with the return rate of the next period, and the reverse momentum strategy is carried out; a total of four investment portfolio construction methods: (1) TB/BT: Buy Top and Sell Bottom when the IC value is positive; Buy Bottom and Sell Top when the IC value is negative; the return is calculated as the difference in returns between the two groups of stocks; (2) buyT/buyB: Buy Top when the IC value is positive; Buy Bottom when the IC value is negative; (3) buyT/sellB: Buy Top when the IC value is positive; Sell Bottom when the IC value is negative; (4) sellB/sellT: Sell Bottom when the IC value is positive; Sell Top when the IC value is negative; Step 208, disregarding whether the obtained predicted IC value is positive or negative and applying the same operation in all cases; this results in five construction methods: (1) buyT: Buy Top; (2) buyB: Buy Bottom; (3) sellT: Sell Top; (4) sellB: Sell Bottom; (5) buyTsellB: Buy Top and Sell Bottom simultaneously, where the return is calculated as the difference in returns between the two groups of stocks, and the stocks being constructed an investment portfolio by sorting the momentum from high to low and dividing it into groups of 10, 20, 50, 100, 200, 500, 1000 and 5000, with each group containing 500, 100, 50, 25, and 1 stock respectively; Step 209, observing the difference between the portfolio return and the logarithmic return of the market (S&P500).

According to an embodiment of the present invention, the stocks in the dominant group represent the stocks with the highest ranking; the stocks in the disadvantaged group represent the stocks with the lowest ranking.

### Logarithmic Return

The rate of return utilized in this invention is the logarithmic return, rather than the simple return. Logarithmic return possesses an additive nature, remaining unaffected by the base period and time; thus, the rate of increase or decrease remains constant. This concept can be expressed as follows:

$${R}_{t + h} = ln ( \frac{{S}_{t + h}}{{S}_{t}} ) . \qquad ( 4 )$$

We denote Rₜ₊ₕ as the return for a holding period of h months, Sₜ₊ₕ as the closing price of the stock at time t+h, and Sₜ as the closing price of the stock at time t. In this paper, h is set to 1, indicating a holding period of 1 month.

### Momentum

In this invention, the momentum employed is referred to as return momentum, which utilizes a formation period of m months. The concept involves dividing the current closing price by the closing price m months ago and taking the logarithm of the resulting quotient. This calculation method remains unaffected by the base period and time.

$${M}_{t , m} = ln ( \frac{{s}_{t}}{{s}_{t - m}} ) . \qquad ( 5 )$$

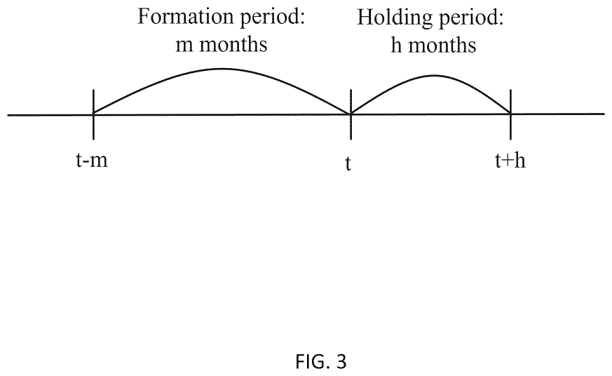

The momentum factors will be calculated using five different time intervals: m=1, 6, 12, 36, and 60 months. FIG. 3 shows a schematic diagram for calculating the return momentum according to an embodiment of the present invention.

### Information Coefficient

The Information Coefficient (IC) is a measure used to assess the predictive ability of investment strategies or models. It calculates the correlation between observed data and actual returns, where the data can represent different characteristics or macroeconomic variables. In this invention, the IC values were computed using momentum factors and logarithmic returns as predictive indicators. Pearson Correlation is used as a statistical method to calculate the IC values, which measures the degree of linear correlation between these two sets of data. The IC value is calculated as the covariance of the two variables divided by the product of their respective standard deviations. In this context, X represents the momentum data, and Y represents the returns. It can be expressed as equation (1) showing above. The correlation between the target factor and the return can be determined through the Information Coefficient (IC). The IC value ranges from 1 to −1. When the IC value is greater than 0, it indicates a positive relationship between the current factor and return. Conversely, when the IC value is less than 0, it indicates a negative relationship between the current factor and the return. The larger the absolute value of the IC, the greater the influence of the factor on the return of investment. There are two common types of IC values:

(i) Normal IC: The correlation coefficient in the cross section between the target factor and the return of holding for h months at time t. It can be expressed as equation (2) showing above.
(ii) Rank IC: The correlation coefficient in the cross section between the ranking of the target factor and the ranking of the return of holding for h months at time t. It can be expressed as equation (3) showing above. Where r(M_{t,m}) and r(Rₜ₊ₕ) in equation (3) indicate that the momentum data and logarithmic return have been ranked before calculating the related coefficients.

In this invention, we use Rank IC because Normal IC requires data to follow a normal distribution, which is often not the case with financial data.

### Machine Learning Models

In this invention, we describe the relationship between the predicted IC values and the corresponding predictor variables as an additive prediction error model. It can be represented by the following equation:

$${IC}_{m , i + 1 , t + 1} = {E}_{t} ( {IC}_{m , i + 1 , t + 1} ) + {ε}_{m , i + 1 , t + 1} . \qquad ( 6 )$$

Where:

$${E}_{t} ( {IC}_{m , i + 1 , t + 1} ) = g ( {z}_{m , i , t} ) , \qquad ( 7 )$$

The IC values are calculated at time t=2, . . . , T, while the momentum factors are calculated at time i=t−1=1, . . . , I. The observation period for the momentum factor is as m=1, 6, 12, 36, 60 respectively. ε represents the random error. Our objective is to isolate a representation of Eₜ(IC_{m,i+1,t+1}) as a function of predictor variables that maximizes the out-of-sample explanatory power for realized IC_{m,i,+1t+1}. The aim is to improve the accuracy of predicting IC values by appropriately modeling Eₜ(IC_{m,i+1,t+1}), ensuring that this predictive ability is maximized not only within the sample (observed data) but also out-of-sample (unobserved data). Therefore, the functional form of g(⋅) is left unspecified. Our target is to search for the prediction model from a set of candidates that gives the best prediction performance. The vector of predictors, z_{m,i,t}, consists of the momentum of all stocks at time point t−1 and the IC value at time t. The predictor variables z_{m,i,t} include the momentum of all stocks sorted at time point t−1 and the IC value at time t. It can be represented as:

$${z}_{m , i , t} = ( \begin{matrix}r ( {M}_{t - 1 , m} ) \\ {IC}_{t}\end{matrix} ) . \qquad ( 8 )$$

Where r(M_{t-1,m}) is a 4983×1 vector of the momentum factors at time t−1, ICₜ is a 1×1 vector of the IC value at time t−1. Each result is independent of the other. Also, g(⋅) depends on z only through z_{m,i,t}. This means our prediction does not use information from the history prior to t and the momentum factors prior to t−1. In total, we consider 7 machine learning methods, namely linear regression, random forest, and neural networks (NN1-NN5).

### 1. Simple Linear Regression Model

We begin with the simple linear regression model estimated via ordinary least squares (OLS). The simple linear model imposes those conditional expectations g(⋅) can be approximated by a linear function of the raw predictor variables and the parameter vector, θ,

$$g ( {z}_{m , i , t} ; θ ) = {z}_{m , i , t}^{′} θ . \qquad ( 9 )$$

This model imposes a simple regression specification and does not allow for nonlinear effects or interactions between predictors. The model combines the original predictor variables and the parameter vector by linearly. As a result, the predicted values of the model are weighted linear combinations of the original predictor variables, with the weights determined by the parameter vector θ.

Our baseline estimation of the simple linear model uses a standard least square, or “ [symbol] ₂”, objective function:

$$ℒ ( θ ) = \frac{1}{IT} {\sum }_{i = 1}^{I} {\sum }_{t = 2}^{T} {( {IC}_{m , i + 1 , t + 1} - g ( {z}_{m , i , t} ) )}^{2} . \qquad ( 10 )$$

Minimizing [symbol] (θ) yields the pooled OLS estimator. The convenience of the baseline [symbol] ₂ objective function is that it offers analytical estimates and thus avoids sophisticated optimization and computation.

### 2. Random Forest

Simple linear regression captures individual predictors' nonlinear impact on expected returns but does not account for interactions among predictors. One way to add interactions is to expand the generalized model to include multivariate functions of predictors. However, without a priori assumptions for which interactions to include, the generalized linear model becomes computationally infeasible.

Random Forests offer an alternative approach to address this issue. Before discussing Random Forests, it is important to understand Regression Trees. regression trees have become a popular machine learning approach for incorporating multi-way predictor interactions. Unlike linear models, trees are fully nonparametric and possess a logic that departs markedly from traditional regressions. At a basic level, a tree aims to identify groups of samples with similar behaviors. A tree “grows” in a sequence of steps. At each step, a new “branch” sorts the data leftover from the preceding step into bins based on one of the predictor variables. This sequential branching slices the space of predictors into rectangular partitions and approximates the unknown function g(⋅) with the average value of the outcome variable within each partition.

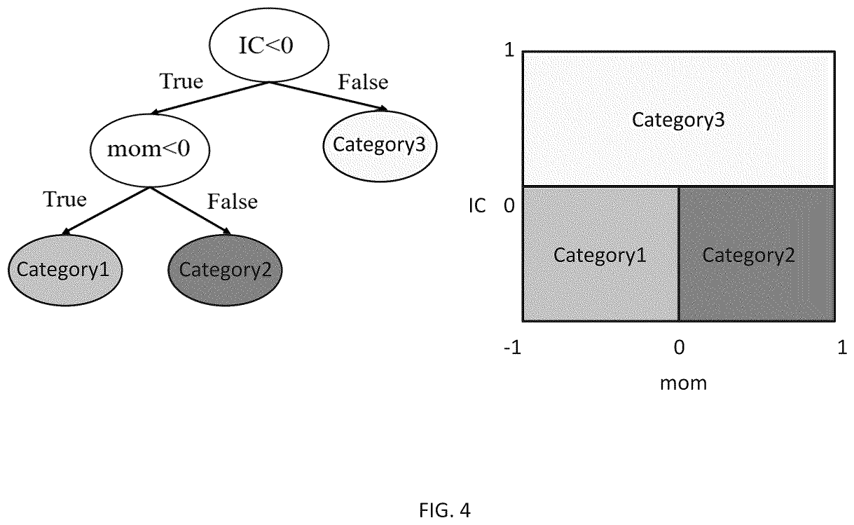

FIG. 4 shows an example with two predictors, “IC” and “mom”. The left panel describes how the tree assigns each observation to a partition based on its predictor values. First, observations are sorted on the IC value. Those above the breakpoint of 0 are assigned to Category 3. Those with negative IC value are then further sorted by mom. Observations with negative IC value and mom below 0 are assigned to Category 1, while those with mom above 0 go into Category 2. Finally, forecasts for observations in each partition are defined as the simple average of the outcome variable's value among observations in that partition.

More formally, the prediction of a tree, T, with K “leaves” (terminal nodes), and depth L, can be written as:

$$g ( {z}_{m , i , t} ; θ , K , L ) = {\sum }_{k = 1}^{K} {θ}_{k} {1}_{\{ {z}_{m , i , t} ϵ {C}_{k} ( L ) \}} , \qquad ( 11 )$$

where Cₖ(L) is one of the K partitions of the data. Each partition is a product of up to L indicator functions of the predictors. The constant associated with partition k (denoted θₖ) is defined to be the sample average of outcomes within the partition. 16 In the example of FIG. 1, the prediction equation is:

$$g ( {z}_{m , i , t} ; θ , 3 , 2 ) = {θ}_{1} {1}_{\{ {IC}_{m , i , t} < 0 \}} {1}_{\{ {mom}_{m , i} < 0 \}} + {θ}_{2} {1}_{\{ {IC}_{m , i , t} < 0 \}} {1}_{\{ {mom}_{m , i} \geq 0 \}} + {θ}_{3} {1}_{\{ {IC}_{m , i , t} \geq 0 \}} , \qquad ( 12 )$$

Random Forest is a model that consists of multiple regression trees created using bootstrapping, with the goal of reducing the correlation between different trees. The steps involved in constructing a Random Forest model are as follows:
Step 1: Randomly select M samples from the original dataset of size N using bootstrapping, allowing for the possibility of selecting the same sample multiple times;
Step 2: Construct a regression tree using the selected M samples. This involves recursively partitioning the data based on different predictor variables to create a tree structure;
Step 3: Repeat Steps 1 and 2 iteratively to generate a total of T regression trees. Each tree is built using a different bootstrap sample;
Step 4: For a new input, obtain predictions from each individual tree in the Random Forest;
Step 5: Combine the predictions of the T trees, often using majority voting (for classification problems) or averaging (for regression problems), to obtain the final prediction.

In Random Forest, each individual regression tree is trained on a different subset of the data, ensuring diversity in the predictions. By combining the predictions of multiple trees through majority voting or averaging, Random Forest can provide more robust and accurate predictions compared to a single regression tree.

### 3. Neural Networks

Neural Networks consist of an “input layer” of raw predictors, one or more “hidden layers” that interact and nonlinearly transform the predictors, and an “output layer” that aggregates hidden layers into an ultimate outcome prediction. Analogous to axons in a biological brain, layers of the networks represent groups of “neurons” with each layer connected by “synapses” that transmit signals among neurons of different layers.

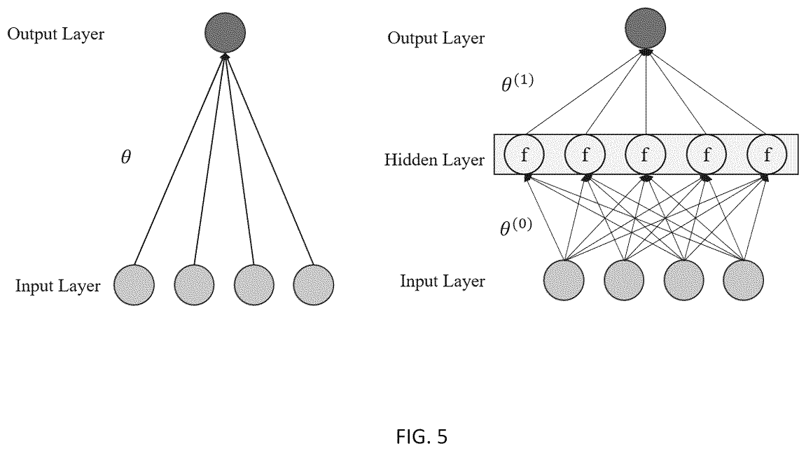

The number of units in the input layer is equal to the dimension of the predictors, which we set to four in this example (denoted z₁, z₂, z₃, z₄). The left panel of FIG. 5 shows the simplest possible network that has no hidden layers. Each of the predictor signals is amplified or attenuated according to a five-dimensional parameter vector, θ, that includes an intercept and one weight parameter per predictor. The output layer aggregates the weighted signals into the forecast θ₀+Σₖ₌₁⁴zₖθₖ; that is, the simplest neural network is a linear regression model.

The model incorporates more flexible predictive associations by adding hidden layers between the inputs and output. The right panel of FIG. 5 shows an example with one hidden layer that contains five neurons. Each neuron draws information linearly from all of the input units, just as in the simple network on the left. Then, each neuron applies a nonlinear “activation function” ƒ to its aggregated signal before sending its output to the next layer. For example, the second neuron in the hidden layer transforms inputs into an output as x₂⁽¹⁾=ƒ(θ_{2,0}⁽⁰⁾+Σⱼ₌₁⁴zⱼθ_{2,j}⁽⁰⁾). Lastly, the results from each neuron are linearly aggregated into an ultimate output forecast:

$$g ( z ; θ ) = {θ}_{0}^{( 1 )} + {\sum }_{j = 1}^{5} {x}_{j}^{( 1 )} {θ}_{j}^{( 1 )} . \qquad ( 13 )$$

Thus, in this example, there are a total of 31=(4+1)×5+6 parameters (five parameters to reach each neuron and six weights to aggregate the neurons into a single output).

We consider architectures with up to five hidden layers. Our shallowest neural network has a single hidden layer of 32 neurons, which we denoted NN1. Next, NN2 has two hidden layers with 32 and 16 neurons, respectively; NN3 has three hidden layers with 32, 16, and 8 neurons, respectively; NN4 has four hidden layers with 32, 16, 8, 4 neurons, respectively; and NN5 has five hidden layers with 32, 16, 8, 4, and 2 neurons, respectively. We choose the number of neurons in each layer according to the geometric pyramid rule. All architectures are fully connected so each unit receives an input from all units in the layer below. By comparing the performance of NN1 through NN5, we can infer the trade-offs of network depth in the return forecasting problem.

After obtaining the predicted IC values for the five different time intervals using machine learning, the absolute values of these predictions are compared, and the maximum absolute value is selected as the final predicted IC value. Stocks with prices below 1 are then removed from consideration. The remaining stocks are sorted based on their momentum strength within this time interval. They are divided into groups of 10, 50, 100, 200, 500, 1000, and 5000, with each group containing 500, 100, 50, 25, 10, 5, and 1 stock, respectively. The group with the strongest momentum is labeled as “Top”, while the group with the weakest momentum is labeled as “Bottom”.

Then, two different observation methods are used to construct the investment portfolio, both employing equal weighting to determine the stock proportion within the investment portfolio. The first method involves observing the original values of the selected predicted IC values before taking the absolute value. It distinguishes between positive and negative values and constructs different operations accordingly. A positive IC value indicates a positive relationship between the momentum factor and future returns, leading to a momentum strategy. Conversely, a negative IC value indicates a negative relationship, resulting in a reverse momentum strategy. This leads to four construction methods: (1) TB/BT: Buy Top and Sell Bottom when the IC value is positive; Buy Bottom and Sell Top when the IC value is negative; the return is calculated as the difference in returns between the two groups of stocks; (2) buyT/buyB: Buy Top when the IC value is positive; Buy Bottom when the IC value is negative; (3) buyT/sellB: Buy Top when the IC value is positive; Sell Bottom when the IC value is negative; (4) sellB/sellT: Sell Bottom when the IC value is positive; Sell Top when the IC value is negative. The second method disregards whether the obtained predicted IC value is positive or negative and applying the same operation in all cases; this results in five construction methods: (1) buyT: Buy Top; (2) buyB: Buy Bottom; (3) sellT: Sell Top; (4) sellB: Sell Bottom; (5) buyTsellB: Buy Top and Sell Bottom simultaneously, where the return is calculated as the difference in returns between the two groups of stocks. In total, there are nine different investment portfolio construction methods using these two approaches.

According to some embodiments of the present invention, all stocks are divided into seven equal parts from high to low according to their momentum, and nine investment portfolio construction methods can create a total of 63 portfolio performance results. Then carry out a finer classification. However, due to the lack of clear motivation and research significance in some investment portfolio construction methods, the present invention will only list the performance of investment portfolios that have research significance and have sufficient reasons to show that they have the possibility of stable absolute returns based on the results of the empirical analysis process, and further explain the significance and motivation of the research after confirming the results.

It should be emphasized here that not all companies were listed at the earliest time point of the data used, so there will be missing values. Considering that the present invention uses the information coefficient as a predictive indicator, adding the average will not cause fluctuations in the IC value of the month. In order to solve the problem of missing values, make the data set closer to the real data, and improve the accuracy of analysis, the mean imputation method of the single Imputation method is used. The filling method is through calculating the average value of other known stock prices in that month, and fill in the missing data. Avoid using the direct deletion method, resulting in excessive loss of data.

### Portfolio Performance: Real IC Values

In this section, investment portfolios will be constructed based on the real IC values for the current month. The momentum of the five intervals (formation periods) will be calculated using logarithmic returns to obtain the IC values. The maximum absolute IC value will be selected, and stocks will be ranked based on their momentum within that time interval. The stocks will then be divided into different percentiles, including the top and bottom 1%, 2%, and 10%. If any stocks in the list have prices below $1, they will be excluded, and the next eligible stocks will be included to maintain the desired number of stocks (50, 100, or 500) in each group. Portfolios will be constructed based on these company lists. Positions will be entered at the end of the previous month and held for a fixed period of one month, exiting at the end of that month. Profits and losses during this period will be calculated as the returns from holding the portfolios for that specific month.

The performance of these portfolios will be observed and analyzed over a period of 100 months, starting from July 2014 to October 2022. Since the prices one month ahead cannot be known in advance, the actual composition of the portfolios at the time of entry cannot be obtained at the beginning of the month. The existence of these portfolios is based on the assumption of early knowledge of the IC values and their accuracy. The performance of the portfolios will be compared to the S&P 500 (Standard & Poor's 500), which has been tracking the average performance of the U.S. stock market since 1957. The S&P 500 includes 500 common stocks, representing approximately 80% of the total market value. It covers a wide range of sectors and is widely regarded as an index that closely reflects the overall market performance. The monthly returns of the portfolios will be compared to the returns of the S&P 500. If a portfolio's return exceeds that of the S&P 500, it implies two research implications: (1) the Information Coefficient (IC) can serve as a predictive indicator, and (2) provides strong motivation for early prediction of IC values and entering the market at the end of the previous month.

According to some embodiments of the present invention, some assumptions are made in the construction of the investment portfolio:

1. Firstly, an assumption is made that equal-weighted buying and selling of each stock within the portfolio is considered at the end of the month. However, it is important to note that practical difficulties may arise in achieving equal weighting due to stock prices and fractional shares.
2. Additionally, the assumption is made that the circuit breaker mechanism in the US stock market is ignored. This means that buying and selling transactions can be executed smoothly, even if there are liquidity issues with certain stocks.
3. Furthermore, it is assumed that there are no constraints, such as account closure or zero funds, when the investment portfolio incurs losses. Even if the return rate falls below −100%, the calculations will still be performed.
4. Lastly, no transaction costs are taken into account in the analysis. This assumption implies that buying and selling stocks within the portfolio do not incur any fees or charges typically associated with transactions in the real market.

Table 1 presents the performance of an investment portfolio constructed using real IC values with an equal-weighted approach, employing a buyTsellB strategy. This strategy involves purchasing the top-performing stocks and selling the bottom-performing stocks. The performance statistics include the average monthly return, monthly standard deviation, and Sharpe ratio, which is calculated using the risk-free rate based on the yield of the US 10-year Treasury bond. The data covers the period from July 2014 to October 2022, encompassing 100 months. The results demonstrate that portfolios constructed using the top 1% and 2% momentum stocks exhibit significantly better average monthly returns and Sharpe ratio compared to the S&P 500 index. This indicates the potential benefits of early prediction of IC values and the construction of momentum strategies.

TABLE 1
Real IC Stock-level buyTsellB Performance (2014 July-2022 October)

| | 1% | | | 2% | | | 10% | | |
|---|---|---|---|---|---|---|---|---|---|
| | Average | Standard | Sharpe | Average | Standard | Sharpe | Average | Standard | Sharpe |
| buyTsellB | return | deviation | ratio | return | deviation | ratio | return | deviation | ratio |
| Portfolio | 7.78% | 9.30% | 0.835 | 5.24% | 7.51% | 0.696 | 0.70% | 4.43% | 0.153 |
| S&P500 | 0.75% | 4.49% | 0.163 | 0.75% | 4.49% | 0.163 | 0.75% | 4.49% | 0.163 |

A positive IC value indicates a positive relationship between the momentum factor and returns, while a negative IC value indicates a negative relationship. This characteristic is employed to examine whether the contrarian strategy yields abnormal returns. Table 2, Table 3, and Table 4 present the performance of the buyT/buyB, sellB/sellT, and TB/BT strategies, respectively. These strategies involve constructing portfolios using real IC values with an equal-weighted approach. In these tables, a momentum strategy is adopted if the real IC value for a particular month is positive, whereas a contrarian strategy is employed if the IC value is negative. Among these strategies, the buyT/buyB strategy underperforms the S&P 500 index. However, the sellB/sellT strategy exhibits better average monthly returns and Sharpe ratio compared to the S&P 500, particularly for portfolios constructed using the top 1%, 2%, and 10% momentum stocks. The TB/BT strategy also outperforms the S&P 500 in terms of average monthly returns for portfolios constructed using the top 1% and 2% momentum stocks. These findings support the motivation for early prediction of IC values and constructing both momentum and contrarian strategies based on positive and negative IC values.

TABLE 2
Real IC Stock-level buyT/buyB Performance (2014 July-2022 October)

| | 1% | | | 2% | | | 10% | | |
|---|---|---|---|---|---|---|---|---|---|
| | Average | Standard | Sharpe | Average | Standard | Sharpe | Average | Standard | Sharpe |
| buyT/buyB | return | deviation | ratio | return | deviation | ratio | return | deviation | ratio |
| Portfolio | −0.93% | 9.30% | −0.101 | −1.01% | 8.99% | −0.115 | −1.08% | 7.98% | −0.138 |
| S&P500 | 0.75% | 4.49% | 0.163 | 0.75% | 4.49% | 0.163 | 0.75% | 4.49% | 0.163 |

TABLE 3
Real IC Stock-level sellB/sellT Performance (2014 July-2022 October)

| | 1% | | | 2% | | | 10% | | |
|---|---|---|---|---|---|---|---|---|---|
| | Average | Standard | Sharpe | Average | Standard | Sharpe | Average | Standard | Sharpe |
| sellB/sellT | return | deviation | ratio | return | deviation | ratio | return | deviation | ratio |
| Portfolio | 2.37% | 10.80% | 0.218 | 2.24% | 9.33% | 0.238 | 1.42% | 6.75% | 0.208 |
| S&P500 | 0.75% | 4.49% | 0.163 | 0.75% | 4.49% | 0.163 | 0.75% | 4.49% | 0.163 |

TABLE 4
Real IC Stock-level TB.BT Performance (2014 July-2022 October)

| | 1% | | | 2% | | | 10% | | |
|---|---|---|---|---|---|---|---|---|---|
| | Average | Standard | Sharpe | Average | Standard | Sharpe | Average | Standard | Sharpe |
| TB/BT | return | deviation | ratio | return | deviation | ratio | return | deviation | ratio |
| Portfolio | 1.45% | 12.07% | 0.118 | 1.23% | 9.09% | 0.133 | 0.34% | 4.47% | 0.072 |
| S&P500 | 0.75% | 4.49% | 0.163 | 0.75% | 4.49% | 0.163 | 0.75% | 4.49% | 0.163 |

Based on the analysis of the empirical results, several preliminary conclusions can be drawn: (1) The positive average monthly returns indicate that the investment portfolios constructed using IC values calculated from momentum factors have implied excess returns. (2) The portfolios constructed using real IC values assume perfect prediction of IC values at the end of the previous month. This assumption is essential for the previous conclusion. If it becomes possible to predict IC values accurately, and the investment portfolio constructed using the predicted values approaches the performance of the portfolio constructed using real IC values, there is a motivation to accurately predict IC values at the end of the previous month.

### Portfolio Performance: Predictive IC Values Using Machine Learning

In continuation of previous paragraph, this section aims to explore the prediction of IC values using three machine learning methods: linear regression, random forest, and neural networks (specifically, NN1, NN2, NN3, NN4, and NN5). The objective is to categorize companies into top-performing and bottom-performing stocks based on the momentum factor, with the goal of generating investment portfolios that can potentially achieve abnormal returns in advance. The accuracy of the machine learning models will be examined initially, and investment portfolios will be constructed using the models with high accuracy. Similar to the previous approach, the portfolios will be entered into the market at the end of the previous month, and their performance will be observed over a one-month holding period. A comparison will be made against the S&P 500 index to determine whether it is possible to obtain IC values earlier through the predictive power of machine learning. Additionally, different strategies will be examined to evaluate the implications of the momentum factor in generating implicit excess returns. By conducting this analysis, we aim to assess the viability of using machine learning techniques to predict IC values and determine their potential in improving investment strategies. The findings will contribute to the understanding of early prediction of IC values and the development of effective entry strategies for investment portfolios.

The present invention utilized the elements of the Confusion Matrix to calculate four evaluation metrics: Accuracy, Precision, Recall, and F1-Score. The elements of the Confusion Matrix are presented in Table 6 as follows:

TABLE 5
Confusion Matrix

TRUE

| | | |
|---|---|---|
| Confusion Matrix | Positive | Negative |

| | | | |
|---|---|---|---|
| Predict | Positive | TP | FP |
| | Negative | FN | TN |

In the Confusion Matrix, the investment portfolios with positive returns are classified as “Positive,” and those with negative returns are classified as “Negative.” “Predicted” represents the investment portfolios constructed based on predicted IC values, while “True” represents the investment portfolios constructed based on true IC values. The four elements of the Confusion Matrix are as follows:
(i) True Positive (TP): Predicted as positive and true value is positive;
(ii) True Negative (TN): Predicted as negative and true value is negative;
(iii) False Positive (FP): Predicted as positive but true value is negative;
(iv) False Negative (FN): Predicted as negative but true value is positive.

These four elements can be used to calculate the four-evaluation metrics: Accuracy, Precision, Recall, and F1-Score.

$$Accuracy = \frac{T P + T N}{T P + F P + F N + T N} \qquad ( 14 )$$

Accuracy represents the consistency of the predicted returns with the true returns in terms of their positive or negative direction among all outcomes.

$$Precision = \frac{T P}{T P + F P} \qquad ( 15 )$$

Precision is a metric that measures the proportion of accurately predicted positive returns out of all instances that were predicted as positive.

$$Recall = \frac{T P}{T P + F N} \qquad ( 16 )$$

Recall is a metric that measures the proportion of correctly identified positive returns out of all instances that were actually positive.

$$F 1 - score = \frac{2}{\frac{1}{Precision} + \frac{1}{Recall}} \qquad ( 17 )$$

F1-score is a metric that combines both precision and recall providing a balanced measure of the two in predicting positive returns.

The statistics in Table 7, Table 8, and Table 9 demonstrate the consistency between predicted and actual returns for the buyTsellB strategy at the 1%, 2%, and 10% levels, based on the predictions of various machine learning models over 100 prediction runs. There is a higher probability of correct directional predictions, indicating the effectiveness of the models in capturing the momentum factors. Furthermore, it is observed that the accuracy tends to increase as the number of stocks included in the portfolio decreases. This suggests that constructing portfolios with a smaller number of stocks can potentially yield higher accuracy. In terms of average monthly returns shown in Table 7, Table 8, and Table 9, positive returns are achieved by constructing the buyTsellB strategy based on the predicted IC values. This highlights the explanatory power of using momentum factors to construct momentum strategies. Additionally, portfolios with a smaller number of stocks tend to generate higher returns. It is important to note that there is no significant difference in accuracy among the seven machine learning models used in the paper. This indicates that the choice of the specific machine learning algorithm does not greatly impact the accuracy of the predictions for the buyTsellB strategy.

TABLE 6A
Accuracy of the prediction for the buyTsellB Strategy at 1% Level

| 1% | OLS | RF | NN1 | NN2 | NN3 | NN4 | NN5 |
|---|---|---|---|---|---|---|---|
| Accuracy | 90.0% | 90.0% | 89.0% | 87.0% | 88.0% | 87.0% | 82.0% |
| Precision | 93.0% | 89.4% | 91.0% | 89.0% | 90.9% | 90.8% | 88.4% |
| Recall | 95.2% | 100.0% | 96.4% | 96.4% | 95.2% | 94.0% | 90.5% |
| F1-Score | 94.1% | 94.4% | 93.6% | 92.6% | 93.0% | 92.4% | 89.4% |

TABLE 6B
Average return for the buyTsellB Strategy at 1% Level

| 1% | OLS | RF | NN1 | NN2 | NN3 | NN4 | NN5 |
|---|---|---|---|---|---|---|---|
| Average | 9.008% | 9.760% | 9.505% | 9.793% | 9.170% | 8.638% | 9.339% |
| Return | | | | | | | |

TABLE 7A
Accuracy of the prediction for the buyTsellB Strategy at 2% Level

| 2% | OLS | RF | NN1 | NN2 | NN3 | NN4 | NN5 |
|---|---|---|---|---|---|---|---|
| Accuracy | 83.0% | 87.0% | 84.0% | 84.0% | 82.0% | 84.0% | 82.0% |
| Precision | 89.0% | 87.8% | 86.5% | 86.5% | 87.1% | 89.2% | 87.1% |
| Recall | 90.1% | 97.5% | 95.1% | 95.1% | 91.4% | 91.4% | 91.4% |
| F1-Score | 89.6% | 92.4% | 90.6% | 90.6% | 89.2% | 90.2% | 89.2% |

TABLE 7B
Average return for the buyTsellB Strategy at 2% Level

| 2% | OLS | RF | NN1 | NN2 | NN3 | NN4 | NN5 |
|---|---|---|---|---|---|---|---|
| Average | 5.703% | 6.258% | 5.989% | 6.624% | 5.641% | 5.204% | 5.926% |
| Return | | | | | | | |

TABLE 8A
Accuracy of the prediction for the buyTsellB Strategy at 10% Level

| 10% | OLS | RF | NN1 | NN2 | NN3 | NN4 | NN5 |
|---|---|---|---|---|---|---|---|
| Accuracy | 84.0% | 88.0% | 86.0% | 84.0% | 85.0% | 83.0% | 73.0% |
| Precision | 88.7% | 88.1% | 87.7% | 86.0% | 90.4% | 90.0% | 75.0% |
| Recall | 82.5% | 91.2% | 87.7% | 86.0% | 82.5% | 78.9% | 78.9% |
| F1-Score | 85.5% | 89.7% | 87.7% | 86.0% | 86.2% | 84.1% | 76.9% |

TABLE 8B
Average return for the buyTsellB Strategy at 10% Level

| 10% | OLS | RF | NN1 | NN2 | NN3 | NN4 | NN5 |
|---|---|---|---|---|---|---|---|
| Average | 0.539% | 0.880% | 0.954% | 0.837% | 0.552% | 0.397% | 1.007% |
| Return | | | | | | | |

Next, we observe the statistics of TB/BT strategy adding 1%, 2% and 10% of the reverse momentum strategy. The statistics in Table 9A, Table 10A and Table 11A reflect the accuracy of the TB/BT strategy at the 1%, 2%, and 10% levels based on predictions from various machine learning models and the predictions of various machine learning models over 100 prediction runs. It is observed that the accuracy of all four-evaluation metrics significantly decreases compared to the buyTsellB strategy. This suggests that incorporating the contrarian strategy using predicted IC values leads to lower accuracy in general. Additionally, there is no significant difference in accuracy among the seven machine learning models used in the present invention, indicating that the choice of specific machine learning algorithms does not greatly impact the accuracy of predictions for the TB/BT strategy. Furthermore, the average monthly returns presented in Table 9B, Table 10B, and Table 11B indicate that almost all average monthly returns are negative for the TB/BT strategy at the 1%, 2%, and 10% levels. This suggests that constructing the TB/BT strategy based on predicted IC values does not improve overall returns and may not be effective in generating positive returns. Incorporating the contrarian strategy using predicted IC values does not appear to yield favorable outcomes in terms of average monthly returns.

TABLE 9A
Accuracy of the prediction for the TB/BT Strategy at 1% Level

| 1% | OLS | RF | NN1 | NN2 | NN3 | NN4 | NN5 |
|---|---|---|---|---|---|---|---|
| Accuracy | 65.0% | 51.0% | 48.0% | 58.0% | 50.0% | 54.0% | 51.0% |
| Precision | 70.7% | 71.4% | 50.0% | 60.4% | 53.1% | 56.5% | 53.2% |
| Recall | 55.8% | 9.6% | 42.3% | 55.8% | 32.7% | 50.0% | 48.1% |
| F1-Score | 62.4% | 16.9% | 45.8% | 58.0% | 40.5% | 53.1% | 50.5% |

TABLE 9B
Average return for the TB/BT Strategy at 1% Level

| 1% | OLS | RF | NN1 | NN2 | NN3 | NN4 | NN5 |
|---|---|---|---|---|---|---|---|
| Average | −0.881% | −9.723% | −0.212% | −0.874% | −3.877% | −0.787% | −2.099% |
| Return | | | | | | | |

TABLE 10A
Accuracy of prediction for the TB/BT Strategy at 2% Level

| 2% | OLS | RF | NN1 | NN2 | NN3 | NN4 | NN5 |
|---|---|---|---|---|---|---|---|
| Accuracy | 60.0% | 52.0% | 46.0% | 53.0% | 48.0% | 55.0% | 55.0% |
| Precision | 60.5% | 54.5% | 43.9% | 52.3% | 45.2% | 54.8% | 54.5% |
| Recall | 53.1% | 12.2% | 36.7% | 46.9% | 28.6% | 46.9% | 49.0% |
| F1-Score | 56.5% | 20.0% | 40.0% | 49.5% | 35.0% | 50.5% | 51.6% |

TABLE 10B
Average return for the TB/BT Strategy at 2% Level

| 2% | OLS | RF | NN1 | NN2 | NN3 | NN4 | NN5 |
|---|---|---|---|---|---|---|---|
| Average | −0.574% | −6.226% | −0.230% | −0.861% | −2.386% | −0.557% | −1.003% |
| Return | | | | | | | |

TABLE 11A
Accuracy of prediction for the TB/BT Strategy at 10% Level

| 10% | OLS | RF | NN1 | NN2 | NN3 | NN4 | NN5 |
|---|---|---|---|---|---|---|---|
| Accuracy | 63.0% | 55.0% | 49.0% | 51.0% | 55.0% | 56.0% | 50.0% |
| Precision | 59.3% | 52.5% | 46.0% | 48.1% | 52.0% | 53.1% | 47.2% |
| Recall | 68.1% | 44.7% | 48.9% | 55.3% | 55.3% | 55.3% | 53.2% |
| F1-Score | 63.4% | 48.3% | 47.4% | 51.5% | 53.6% | 54.2% | 50.0% |

TABLE 11B
Average return for the TB/BT Strategy at 10% Level

| 10% | OLS | RF | NN1 | NN2 | NN3 | NN4 | NN5 |
|---|---|---|---|---|---|---|---|
| Average | 0.299% | −0.900% | −0.046% | −0.009% | −0.191% | −0.020% | 0.372% |
| Return | | | | | | | |

### Portfolio Performance

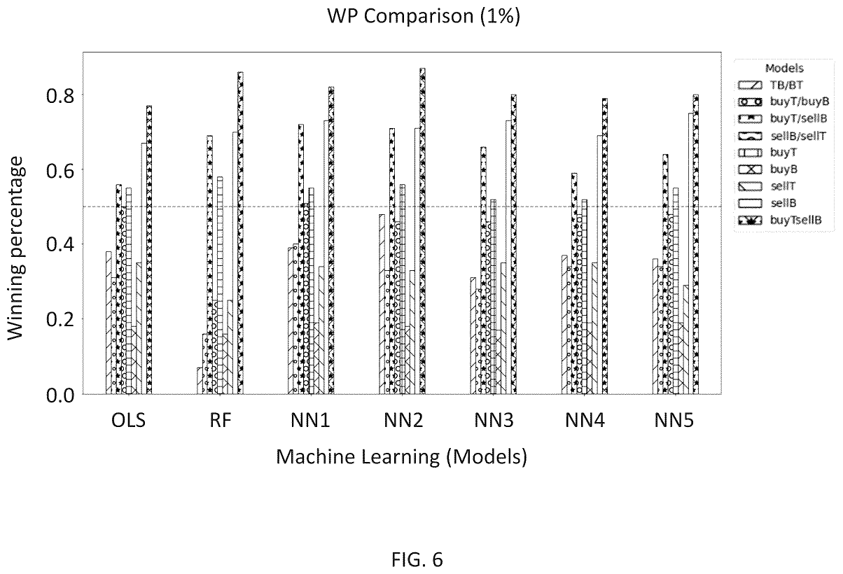

In Table 12, the returns and win rates of 9 investment portfolios are compared, with each portfolio constructed based on the top and bottom 1% momentum stocks. The portfolios buyT/sellB, buyT, sellB, and buyTsellB consistently achieve win rates exceeding 50% across different machine learning models, as illustrated in FIG. 6, indicating their effectiveness in constructing momentum strategies using predicted IC values. On the other hand, portfolios TB/BT, buyT/buyB, sellB/sellT, buyB, and sellT exhibit win rates below 50%, suggesting limited effectiveness when operations are based on positive and negative IC values or when implementing contrarian strategies.

TABLE 12
Comparison Win Rates for 9 Investment Portfolios at 1% Level

| | OLS | RF | NN1 | NN2 | NN3 | NN4 | NN5 |
|---|---|---|---|---|---|---|---|
| TB/BT | 38% | 7% | 39% | 48% | 31% | 37% | 36% |
| buyT/buyB | 31% | 16% | 40% | 33% | 28% | 34% | 34% |
| buyT/sellB | 56% | 69% | 72% | 71% | 66% | 59% | 64% |
| sellB/sellT | 50% | 25% | 51% | 46% | 46% | 48% | 48% |
| buyT | 55% | 58% | 55% | 56% | 52% | 52% | 55% |
| buyB | 18% | 16% | 19% | 18% | 17% | 19% | 19% |
| sellT | 35% | 25% | 34% | 33% | 35% | 35% | 29% |
| sellB | 67% | 70% | 73% | 71% | 73% | 69% | 75% |
| buyTsellB | 77% | 86% | 82% | 87% | 80% | 79% | 80% |

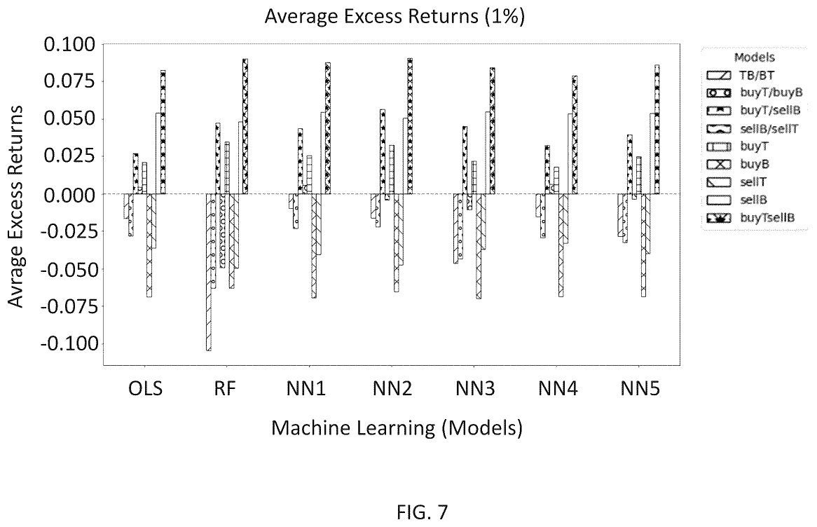

Table 13 shows the average excess monthly returns of the 100 constructed portfolios over the period from July 2014 to October 2022. The buyTsellB strategy stands out with the highest average excess monthly return, indicating its significant abnormal returns compared to the S&P 500. These results in FIG. 6 and FIG. 7 complement each other, highlighting the consistent profitability of momentum strategies constructed using predicted IC values in the US stock market.

TABLE 13
Average Excess Monthly Returns at 1% Level

| | OLS | RF | NN1 | NN2 | NN3 | NN4 | NN5 |
|---|---|---|---|---|---|---|---|
| TB/BT | −1.32% | −6.97% | −0.98% | −1.61% | −3.13% | −1.31% | −1.75% |
| buyT/buyB | −2.57% | −4.78% | −2.43% | −2.21% | −3.66% | −2.68% | −2.94% |
| buyT/sellB | 0.84% | 3.23% | 2.66% | 3.89% | 3.08% | 1.65% | 2.10% |
| sellB/selIT | 0.49% | −2.94% | 0.70% | −0.15% | −0.23% | 0.62% | 0.44% |
| buyT | 0.57% | 1.46% | 0.68% | 1.53% | 0.36% | 0.20% | 0.52% |
| buyB | −5.13% | −4.80% | −5.31% | −5.09% | −5.28% | −5.00% | −5.40% |
| sellT | −2.07% | −2.96% | −2.18% | −3.03% | −1.85% | −1.70% | −2.02% |
| sellB | 3.63% | 3.30% | 3.81% | 3.59% | 3.79% | 3.50% | 3.91% |
| buyTsellB | 4.95% | 5.51% | 5.24% | 5.88% | 4.89% | 4.46% | 5.18% |

Next, we will examine the four portfolios (buyT/sellB, buyT, sellB, and buyTsellB) that have significant positive returns.

### 1. buyT/sellB

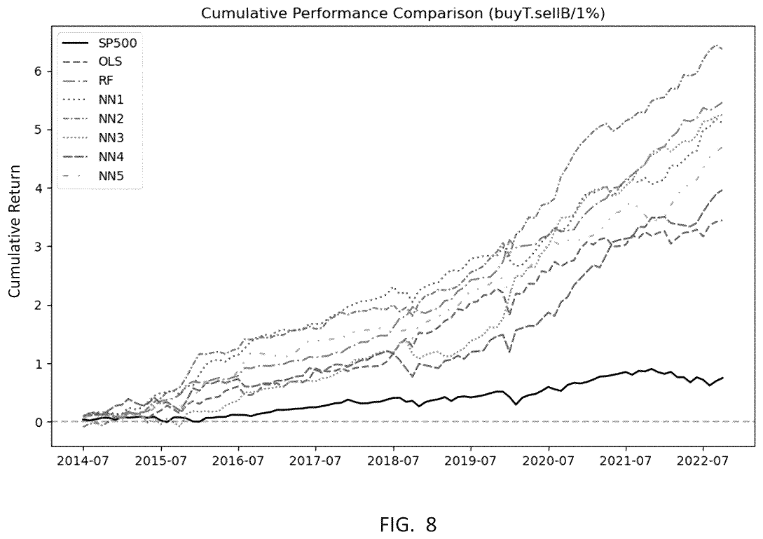

Table 14 presents the performance of the buyT/sellB strategy constructed using machine learning models for the top and bottom 1%, 2%, and 10% portfolios. Across all machine learning models, the buyT/sellB strategy outperforms both the S&P 500 and the buyT/sellB strategy constructed using real IC values for the 1% and 2% portfolios. This suggests that incorporating predicted IC values from the machine learning models leads to improved performance. FIG. 8 is the run chart of the Cumulative Returns of buyT/sellB at 1% Level. Furthermore, the portfolios with a smaller number of stocks exhibit higher excess returns. This implies that constructing portfolios with a concentrated selection of top-performing and bottom-performing stocks can potentially enhance returns. Among the machine learning models, the buyT/sellB strategy constructed using the NN2 model yields the most significant positive returns, indicating the effectiveness of this particular model for predicting IC values and generating excess returns. The buyT/sellB strategy operates based on the predicted IC values, where a positive IC value triggers a buyT operation, and a negative IC value triggers a sellB operation. By incorporating the observed positive and negative IC values from the machine learning models into the buyT/sellB strategy, significant absolute returns can be achieved.

TABLE 14
Performance of buyT/sellB Strategy Using Machine Learning Models

| | 1% | | | 2% | | | 10% | | |
|---|---|---|---|---|---|---|---|---|---|
| | Average | Standard | Sharpe | Average | Standard | Sharpe | Average | Standard | Sharpe |
| buyT/sellB | return | deviation | ratio | return | deviation | ratio | return | deviation | ratio |
| OLS | 3.45% | 10.00% | 0.343 | 1.59% | 9.08% | 0.173 | −0.96% | 7.92% | −0.123 |
| RF | 5.46% | 7.20% | 0.756 | 3.98% | 6.70% | 0.591 | 1.27% | 5.97% | 0.209 |
| NN1 | 5.11% | 8.93% | 0.570 | 3.41% | 8.82% | 0.385 | 0.60% | 7.62% | 0.076 |
| NN2 | 6.37% | 9.51% | 0.668 | 4.63% | 8.96% | 0.515 | 1.54% | 7.99% | 0.191 |
| NN3 | 5.25% | 9.57% | 0.546 | 3.83% | 8.98% | 0.425 | 0.92% | 7.26% | 0.124 |
| NN4 | 3.97% | 9.76% | 0.405 | 2.39% | 9.11% | 0.261 | −0.08% | 8.31% | −0.012 |
| NN5 | 4.70% | 9.33% | 0.502 | 2.84% | 8.54% | 0.331 | 0.59% | 7.31% | 0.079 |
| real IC | 2.83% | 8.91% | 0.315 | 1.48% | 8.92% | 0.164 | −0.86% | 8.00% | −0.110 |
| S&P500 | 0.75% | 4.49% | 0.163 | 0.75% | 4.49% | 0.163 | 0.75% | 4.49% | 0.163 |

### 2. buyT

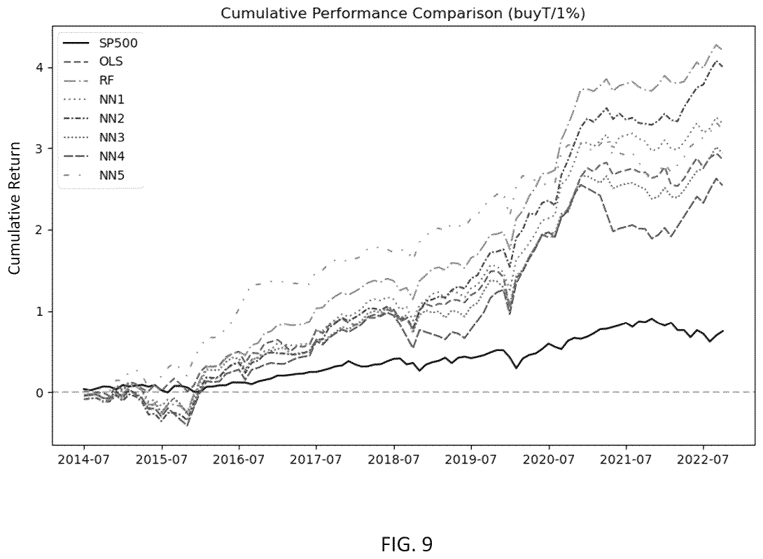

Table 15 presents the performance of the buyT strategy constructed using machine learning models for the top 1%, 2%, and 10% portfolios. Across all machine learning models, the buyT strategy outperforms both the S&P 500 and the buyT strategy constructed using real IC values for the 1% and 2% portfolios. This suggests that incorporating predicted IC values from the machine learning models leads to improved performance. Furthermore, portfolios with a smaller number of stocks exhibit higher excess returns, indicating the potential benefits of constructing concentrated portfolios of top-performing stocks. Among the machine learning models, the buyT strategy constructed using the Random Forest model yields more significant positive returns, suggesting its effectiveness in predicting IC values and generating excess returns. FIG. 9 illustrates the cumulative returns of the buyT strategies, it is evident that constructing momentum strategies based on predicted IC values obtained from machine learning models can generate absolute returns. However, it is noted that constructing contrarian strategies based on IC values, as represented by the buyB strategy, does not result in positive returns.

TABLE 15
Performance of buyT Strategy Using Machine Learning Models

| | 1% | | | 2% | | | 10% | | |
|---|---|---|---|---|---|---|---|---|---|
| | Average | Standard | Sharpe | Average | Standard | Sharpe | Average | Standard | Sharpe |
| buyT | return | deviation | ratio | return | deviation | ratio | return | deviation | ratio |
| OLS | 2.86% | 10.22% | 0.278 | 1.32% | 9.83% | 0.133 | −0.97% | 8.38% | −0.118 |
| RF | 4.21% | 9.92% | 0.423 | 2.21% | 9.56% | 0.229 | −0.45% | 8.39% | −0.056 |
| NN1 | 3.31% | 10.02% | 0.329 | 1.43% | 9.78% | 0.144 | −0.65% | 8.41% | −0.079 |
| NN2 | 4.00% | 10.05% | 0.397 | 2.28% | 9.67% | 0.234 | −0.63% | 8.47% | −0.076 |
| NN3 | 2.94% | 10.10% | 0.290 | 1.11% | 9.53% | 0.114 | −0.95% | 8.20% | −0.117 |
| NN4 | 2.54% | 10.73% | 0.235 | 0.95% | 10.06% | 0.093 | −0.95% | 8.51% | −0.114 |
| NN5 | 3.23% | 9.90% | 0.325 | 1.27% | 9.65% | 0.130 | −0.84% | 8.04% | −0.106 |
| real IC | 2.24% | 10.42% | 0.214 | 1.00% | 9.99% | 0.098 | −0.91% | 8.38% | −0.110 |
| S&P500 | 0.75% | 4.49% | 0.163 | 0.75% | 4.49% | 0.163 | 0.75% | 4.49% | 0.163 |

### 3. sellB

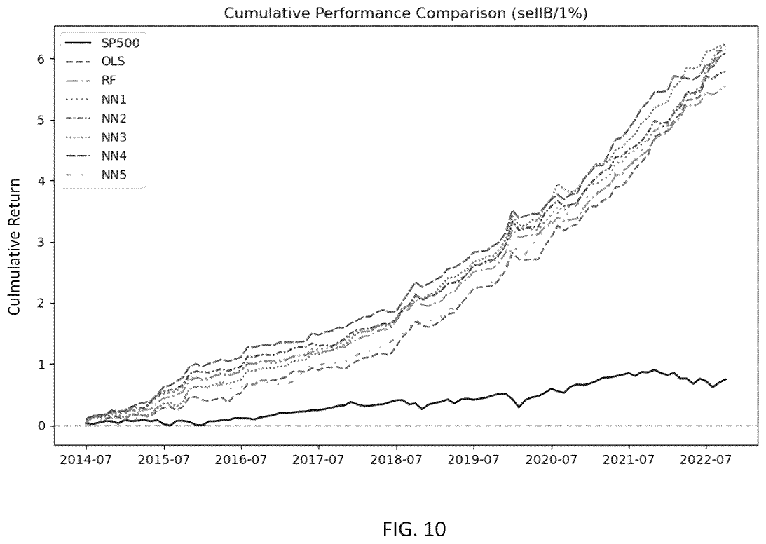

Table 16 presents the performance of the sellB strategy constructed using machine learning models for the top 1%, 2%, and 10% portfolios. Across all machine learning models, the sellB strategy outperforms both the S&P 500 and the sellB strategy constructed using real IC values for the 1%, 2%, and 10% portfolios. This suggests that incorporating predicted IC values from the machine learning models leads to improved performance. Moreover, portfolios with a smaller number of stocks exhibit higher excess returns, indicating the potential benefits of constructing concentrated portfolios of bottom-performing stocks. Among the machine learning models, the sellB strategy constructed using the NN3 model generates slightly more significant positive returns, suggesting its effectiveness in predicting IC values and generating excess returns. FIG. 10 illustrates the cumulative returns of the sellB and sellT strategies. It is evident that constructing momentum strategies based on predicted IC values obtained from machine learning models can generate absolute returns. The sellB strategy consistently outperforms the sellT strategy, indicating the effectiveness of the momentum strategy in capturing positive returns. However, it is noted that constructing contrarian strategies based on IC values, as represented by the sellT strategy, does not result in positive returns.

TABLE 16
Performance of sellB Strategy Using Machine Learning Models

| | 1% | | | 2% | | | 10% | | |
|---|---|---|---|---|---|---|---|---|---|
| | Average | Standard | Sharpe | Average | Standard | Sharpe | Average | Standard | Sharpe |
| sellB | return | deviation | ratio | return | deviation | ratio | return | deviation | ratio |
| OLS | 6.15% | 8.63% | 0.711 | 4.38% | 7.73% | 0.564 | 1.51% | 6.69% | 0.223 |
| RF | 5.55% | 7.15% | 0.775 | 4.05% | 6.66% | 0.605 | 1.33% | 5.95% | 0.221 |
| NN1 | 6.19% | 7.82% | 0.790 | 4.56% | 7.37% | 0.616 | 1.61% | 6.47% | 0.245 |
| NN2 | 5.79% | 7.61% | 0.758 | 4.34% | 6.99% | 0.618 | 1.46% | 6.15% | 0.235 |
| NN3 | 6.23% | 8.20% | 0.757 | 4.53% | 7.54% | 0.599 | 1.50% | 6.44% | 0.230 |
| NN4 | 6.10% | 7.79% | 0.780 | 4.25% | 7.13% | 0.594 | 1.35% | 6.70% | 0.199 |
| NN5 | 6.10% | 7.54% | 0.807 | 4.66% | 7.33% | 0.633 | 1.84% | 6.44% | 0.283 |
| real IC | 4.96% | 8.80% | 0.562 | 3.51% | 7.94% | 0.440 | 1.01% | 6.47% | 0.154 |
| S&P500 | 0.75% | 4.49% | 0.163 | 0.75% | 4.49% | 0.163 | 0.75% | 4.49% | 0.163 |

### 4. buyTsellB

Both implementing the buyT and sellB strategies individually can generate excess returns. We examine the performance when both strategies are implemented simultaneously. Table 17 presents the performance of the buyTsellB strategy constructed using machine learning models for the top 1%, 2%, and 10% portfolios. Across all machine learning models, the buyTsellB strategy outperforms both the S&P 500 and the buyTsellB strategy constructed using real IC values for the 1%, 2%, and 10% portfolios. This suggests that implementing the buyTsellB strategy based on observed IC values from machine learning models leads to improved performance compared to implementing buyT and sellB strategies separately. Among the machine learning models, the buyTsellB strategy constructed using the NN2 model generates slightly more significant positive returns, highlighting the effectiveness of this model in predicting IC values and generating excess returns. These findings indicate that implementing the buyTsellB strategy based on the observed IC values from machine learning models can generate absolute returns, and the returns are notably superior to implementing buyT and sellB strategies separately. This highlights the potential benefits of combining two momentum strategies in a single approach, leveraging the predictive power of machine learning models to enhance portfolio performance.

TABLE 17
Performance of buyTsellB Strategy Using Machine Learning Models

| | 1% | | | 2% | | | 10% | | |
|---|---|---|---|---|---|---|---|---|---|
| | Average | Standard | Sharpe | Average | Standard | Sharpe | Average | Standard | Sharpe |
| buyTsellB | return | deviation | ratio | return | deviation | ratio | return | deviation | ratio |
| OLS | 9.01% | 9.52% | 0.944 | 5.70% | 7.11% | 0.800 | 0.54% | 3.98% | 0.131 |
| RF | 9.76% | 8.23% | 1.184 | 6.26% | 6.60% | 0.946 | 0.88% | 4.30% | 0.201 |
| NN1 | 9.50% | 8.55% | 1.110 | 5.99% | 6.82% | 0.875 | 0.95% | 4.17% | 0.225 |
| NN2 | 9.79% | 9.23% | 1.059 | 6.62% | 7.19% | 0.918 | 0.84% | 4.44% | 0.185 |
| NN3 | 9.17% | 9.44% | 0.969 | 5.64% | 7.06% | 0.796 | 0.55% | 4.01% | 0.134 |
| NN4 | 8.64% | 8.19% | 1.053 | 5.20% | 6.36% | 0.815 | 0.40% | 3.81% | 0.100 |
| NN5 | 9.34% | 7.78% | 1.199 | 5.93% | 6.32% | 0.935 | 1.01% | 4.30% | 0.230 |
| real IC | 7.78% | 9.30% | 0.835 | 5.24% | 7.51% | 0.696 | 0.70% | 4.43% | 0.153 |
| S&P500 | 0.75% | 4.49% | 0.163 | 0.75% | 4.49% | 0.163 | 0.75% | 4.49% | 0.163 |

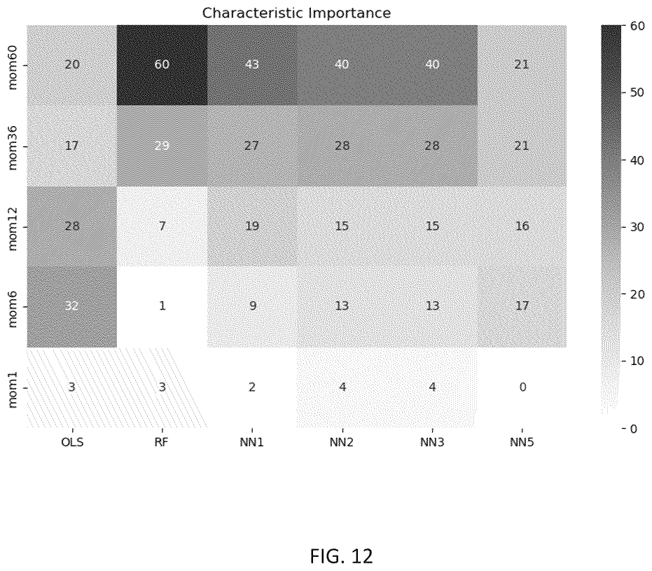

Based on the empirical results discussed above, the result confirms that constructing investment portfolios using machine learning models can generate significant positive returns. The buyT/sellB, buyT, sellB, and buyTsellB portfolios demonstrate strong performance under different machine learning models, with each portfolio achieving the most significant returns in specific scenarios. The buyT/sellB and buyT strategies exhibit notable returns when the portfolio includes stocks in the top and bottom 2% of all stocks, respectively. On the other hand, the sellB and buyTsellB strategies show significant returns when the portfolio contains stocks in the top and bottom 10% of all stocks. This suggests that momentum strategies can be effective, depending on the specific portfolio composition. Furthermore, the empirical results indicate that portfolios with a smaller number of stocks tend to generate better returns. This emphasizes the potential benefits of constructing concentrated portfolios, focusing on a select group of top-performing or bottom-performing stocks. In contrast to the observation that the contrarian strategy using real IC values can yield abnormal returns, the result finds that the contrarian strategy implemented using machine learning models does not generate positive returns. This suggests that the predictive power of the machine learning models may not be strong enough to capture profitable opportunities with the contrarian approach. Moreover, the results indicate that the sellB strategy outperforms the buyT strategy in terms of returns, suggesting that shorting stocks with weak momentum yields more significant abnormal returns compared to longing stocks with strong momentum. The most significant returns are achieved when both shorting stocks with weak momentum and longing stocks with strong momentum are implemented simultaneously, as demonstrated by the buyTsellB strategy. Overall, the present invention examines nine investment portfolios, and among them, four portfolios constructed using machine learning models consistently outperform the S&P 500 and the portfolios constructed using real IC values. This confirms the conclusion that constructing investment portfolios based on predicted IC values obtained from machine learning models can generate absolute positive returns. The findings highlight the potential of leveraging machine learning techniques for improved portfolio performance and the importance of considering both momentum and contrarian strategies in the investment decision-making process. In order to evaluate the impact of different momentum factors on the performance of various machine learning models, we selected the momentum factor with the highest absolute value of predicted IC values for five observation periods per month. According some embodiments of the present invention, we then calculated the frequency of usage for each momentum factor in 100 predictions. Among them, mom1, mom6, mom12, mom36 and mom60 respectively represent the momentum factors corresponding to the length of the observation period m=1, 6, 12, 36 and 60. A higher frequency indicates a relatively greater importance of the momentum factor for the corresponding machine learning model. FIG. 12 presents the ranking of the importance of various momentum factors for different machine learning models, based on different observation periods. The vertical axis represents the momentum factors, with the factor that has the highest frequency of usage positioned at the top of the graph, and the factor with the lowest frequency at the bottom. The grayscale gradient within each column indicates the ranking of the importance of a specific momentum factor for the corresponding machine learning model. The grayscales range from the least important (lightest grayscale) to the most important (darkest grayscale). From FIG. 12, we can observe that the rankings of all six machine learning models, except for the linear regression model, are highly consistent. This consistency suggests a relative importance of different momentum factors that remains consistent across various machine learning models and different observation periods. The results indicate that longer observation periods of momentum factors show a stronger correlation with returns. Using longer observation periods to predict IC values for constructing investment portfolios leads to more significant results. This highlights the importance of considering longer-term momentum factors when predicting future performance and constructing effective investment strategies. This finding emphasizes the consistent and influential role of various momentum factors in the performance of different machine learning models. The results suggest that longer observation periods of momentum factors are more closely linked to returns. This underscores the significance of incorporating these factors into the prediction process for constructing successful investment portfolios. Those skilled in the art should understand that the aforementioned methods can be embodied in instructions and can be stored and/or executed as hardware, software or firmware without departing from the spirit of the present invention. Furthermore, it is understood that the exact configuration of the computer computing or processing system may vary. Computer computing or processing systems include processors, memory (storage media), wireless transceiver devices, control devices (such as keyboards and pointing devices), video displays, and input/output (I/O) devices. Memory, wireless transceivers, video display, input/output (I/O) devices and any number of other peripheral devices are connected to the microprocessor through a BUS to exchange data with the processor for executing applications. The video display can be a liquid crystal display (LCD) or an organic light emitting diode (OLED) display. Memory is the device that sends and receives data to and from the processor and stores the data. Memory may include non-volatile memory, such as read-only memory (ROM), which stores the instructions and data needed to operate individual subsystems of the processing system and to boot the system at startup. Those skilled in the art will appreciate that any number of memories may be used to perform this function. Memory may also include volatile memory, such as random access memory (RAM), which stores instructions and data required by the processor to execute software instructions for computational processing, such as to provide computational processing required for a system in accordance with the present invention. It will be understood that any type of memory may serve as volatile memory, and the exact type used is left as a design choice to those skilled in the art. A processor, a microprocessor, or any combination of a processor and a microprocessor, which executes operation instructions according to the present invention, can execute various application programs stored in the storage unit. These applications can receive user's input via a display with a touch screen or directly from the keyboard area.

Based on the commonality between performance and technical analysis, other momentum factors with the same attributes can also be applied to the present invention, such as based on past performance: all these momentum factor algorithms evaluate and predict based on the past performance of assets. It is assumed that assets that have performed well in the past are likely to continue to perform well in the future, while assets that have performed poorly in the past may continue to perform poorly. Moreover, most of these momentum factors are technical analysis tools: most of these algorithms are part of technical analysis, using technical tools such as charts, indicators, and moving averages to analyze data such as asset prices and trading volumes. Another example is buy/sell signals: most momentum factor algorithms generate buy or sell signals to allow investors to trade under specific circumstances. For example, when a certain condition is triggered, investors may decide to buy or sell based on signals generated by the algorithm. Therefore, based on these commonalities, the following factors can also be used as prediction tools in the steps or methods proposed by the present invention.

### I. Momentum Factors Based on Price Calculation

1. Simple momentum factor: Calculated based on performance over a fixed period of time, usually using share price or rate of return.

2. Relative strength index (RSI): Assessing the “strength of buyers and sellers” in the stock market being a momentum indicator of technical analysis.

3. Moving average: exponential moving average, weighted moving average, cumulative moving average, etc.

4. MACD: Using two fast and slow EMAs (exponential moving averages) of different speeds to interleave to determine the stock price trend.

### II. Momentum Factors not Based on Price Calculation

1. Earnings momentum factor: Evaluating momentum based on a company's earnings performance.

2. Capital investment momentum factor: Evaluating momentum based on the performance of a company's capital spending, investment and development activities.

3. Fundamental factors: Fundamental factors taking into account the company's fundamental data, such as market capitalization, dividend yield, asset-liability ratio, etc.

4. Economic indicators and index momentum factors: Evaluating momentum based on the performance of economic indicators (such as GDP, unemployment rate, consumer confidence index, etc.) or industry indexes. For example, if the relevant index of an industry has performed well in the past period, this may be interpreted as indicating that the industry has momentum.

While various embodiments of the present invention have been described above, it should be understood that they have been presented by a way of example and not limitation. Numerous modifications and variations within the scope of the invention are possible. The present invention should only be defined in accordance with the following claims and their equivalents.

What is claimed is:

1. A method for construction an investment portfolio through a computer executable program stored in a computer readable storage media by a processor, said method comprising:
calculating logarithmic return and the momentum factor through said processor based on historical stock prices, and storing said logarithmic return and said momentum factor in said computer readable storage media;
calculating information coefficient (IC) values by said processor based on said logarithmic return and said momentum factor, and storing said IC values as screening indicators for investment in said computer readable storage media;
utilizing said processor to exanimate said IC values in a time interval, deleting stocks whose stock price is too small, ranking and storing said stocks according to strength of said momentum factor to make ranking order in said computer readable storage media; and
determining a stock list in an investment portfolio by said processor based on dividing said stocks into groups according to said ranking order, and then stores said investment portfolio in said computer readable storage media.

2. The method of claim 1, further comprising predicting IC values for next time period after performing steps of calculating said IC values through a machine learning model by said processor.

3. The method of claim 2, wherein said momentum factor includes at least one of the following: return momentum, simple momentum factor, relative strength index (RSI), moving average, MACD, profit momentum factor, capital investment momentum factor, fundamental factor, economic indicator and index momentum factor.

4. The method of claim 2, wherein if said IC values are positive, a momentum strategy is carried out; if said IC values are negative, a reverse momentum strategy is carried out.

5. The method of claim 4, wherein said investment portfolio is containing the following approaches: (1) TB/BT: Buy Top and Sell Bottom when the IC value is positive; Buy Bottom and Sell Top when the IC value is negative; (2) buyT/buyB: Buy Top when the IC value is positive; Buy Bottom when the IC value is negative; (3) buyT/sellB: Buy Top when the IC value is positive; Sell Bottom when the IC value is negative; (4) sellB/sellT: Sell Bottom when the IC value is positive; Sell Top when the IC value is negative; wherein said stocks are divided into groups that group with the strongest momentum is labeled as “Top”, while the group with the weakest momentum is labeled as “Bottom”; and wherein said buyT means buy Top, i.e. buy said stocks divided into groups that group with the strongest momentum, said buyB means buy Bottom, i.e. buy said stocks divided into groups that group with the weakest momentum, sellB means sell Bottom, i.e. sell said stocks divided into groups that group with the weakest momentum, sellT means sell Top, i.e. sell said stocks divided into groups that group with the strongest momentum, and TB/BT means buy Bottom and Sell Top simultaneously.

6. The method of claim 2, disregarding whether said predicted IC value is positive or negative and applying the same operation.

7. The method of claim 6, wherein said investment portfolio is containing the following approaches: (1) buyT: Buy Top; (2) buyB: Buy Bottom; (3) sellT: Sell Top; (4) sellB: Sell Bottom; (5) buyTsellB: Buy Top and Sell Bottom simultaneously; wherein said stocks are divided into groups that group with the strongest momentum is labeled as “Top”, while the group with the weakest momentum is labeled as “Bottom”; and wherein said buyT means buy Top, i.e. buy said stocks divided into groups that group with the strongest momentum, said buyB means buy Bottom, i.e. buy said stocks divided into groups that group with the weakest momentum, said sellB means sell Bottom, i.e. sell said stocks divided into groups that group with the weakest momentum, said sellT means sell Top, i.e. sell said stocks divided into groups that group with the strongest momentum.

8. The method of claim 2, wherein said momentum factor is calculated by taking m months as the formation period, divides current closing price of a stock in current period by said closing price of said stock in previous m months, and takes logarithm.

9. The method of claim 2, wherein each of said IC values is calculated as covariance of two variables E[(X−μ_{X})(Y−μ_{Y})] divided by product of their respective standard deviations σ_{X}σ_{Y}, which can be expressed as
$$IC = \frac{Cov ( X , Y )}{{σ}_{X} {σ}_{Y}} = \frac{E [ ( X - {μ}_{X} ) ( Y - {μ}_{Y} ) ]}{{σ}_{X} {σ}_{Y}} .$$

10. The method of claim 9, wherein said IC values are Rank IC values, each Rank IC value is defined as correlation coefficient in the cross section between a ranking of a target factor and a ranking of return of holding for h months at time t.

11. The method of claim 2, wherein said processor utilizes mean imputation method to fill in missing data by calculating the average value of other known stock prices in that month.

12. A method for construction an investment portfolio through a computer executable program by a processor, said method comprising:
calculating logarithmic return and the momentum factor through said processor based on historical stock prices, and storing said logarithmic return and said momentum factor;
calculating information coefficient (IC) values by said processor based on said logarithmic return and said momentum factor, and storing said IC values as screening indicators for investment;
predicting IC values for next time period by said processor through a machine learning model;
utilizing said processor to exanimate said IC values in a time interval, deleting stocks whose stock price is too small, ranking and storing said stocks according to strength of said momentum factor to make ranking order; and
determining a stock list in an investment portfolio by said processor based on dividing said stocks into groups according to said ranking order, and then stores the portfolio.

13. The method of claim 12, further comprising a machine learning model to predict IC values for next time period after performing calculating said IC values.

14. The method of claim 12, wherein said momentum factor includes at least one of the following: return momentum, simple momentum factor, relative strength index (RSI), moving average, MACD, profit momentum factor, capital investment momentum factor, fundamental factor, economic indicator and index momentum factor.

15. The method of claim 12, if said IC values are positive, a momentum strategy is carried out; if said IC values are negative, a reverse momentum strategy is carried out.

16. The method of claim 15, wherein said investment portfolio is containing the following approaches: (1) TB/BT: Buy Top and Sell Bottom when the IC value is positive; Buy Bottom and Sell Top when the IC value is negative; (2) buyT/buyB: Buy Top when the IC value is positive; Buy Bottom when the IC value is negative; (3) buyT/sellB: Buy Top when the IC value is positive; Sell Bottom when the IC value is negative; (4) sellB/sellT: Sell Bottom when the IC value is positive; Sell Top when the IC value is negative; wherein said stocks are divided into groups that group with the strongest momentum is labeled as “Top”, while the group with the weakest momentum is labeled as “Bottom”; and wherein said buyT means buy Top, i.e. buy said stocks divided into groups that group with the strongest momentum, said buyB means buy Bottom, i.e. buy said stocks divided into groups that group with the weakest momentum, sellB means sell Bottom, i.e. sell said stocks divided into groups that group with the weakest momentum, sellT means sell Top, i.e. sell said stocks divided into groups that group with the strongest momentum, and TB/BT means buy Bottom and Sell Top simultaneously.

17. The method of claim 12, disregarding whether said predicted IC value is positive or negative and applying the same operation in all cases.

18. The method of claim 17, wherein said investment portfolio is containing the following approaches: (1) buyT: Buy Top; (2) buyB: Buy Bottom; (3) sellT: Sell Top; (4) sellB: Sell Bottom; (5) buyTsellB: Buy Top and Sell Bottom simultaneously; wherein said stocks are divided into groups that group with the strongest momentum is labeled as “Top”, while the group with the weakest momentum is labeled as “Bottom” and wherein said buyT means buy Top, i.e. buy said stocks divided into groups that group with the strongest momentum, said buyB means buy Bottom, i.e. buy said stocks divided into groups that group with the weakest momentum, said sellB means sell Bottom, i.e. sell said stocks divided into groups that group with the weakest momentum, said sellT means sell Top, i.e. sell said stocks divided into groups that group with the strongest momentum.

19. The method of claim 12, wherein said momentum factor is calculated by taking m months as the formation period, divides current closing price of a stock in current period by said closing price of said stock in previous m months, and takes logarithm.

20. The method of claim 12, wherein each of said IC values is calculated as covariance of two variables E[(X−μ_{X})(Y−μ_{Y})] divided by product of their respective standard deviations σ_{X}σ_{Y}, which can be expressed as
$$IC = \frac{Cov ( X , Y )}{{σ}_{X} {σ}_{Y}} = \frac{E [ ( X - {μ}_{X} ) ( Y - {μ}_{Y} ) ]}{{σ}_{X} {σ}_{Y}} ;$$
and wherein said IC values are Rank IC values, each Rank IC value is defined as correlation coefficient in the cross section between a ranking of a target factor and a ranking of return of holding for h months at time t.
